(19) United States
(12) Patent Application Publication
(10) Pub. No.: US 2008/0126972 A1
(43) Pub. Date: May 29, 2008

(54) Operator control panel event log selection

(76) Inventors: Curtis C. Ballard, Eaton, CO (US); Kelly J. Reasoner, Fort Collins, CO (US); Tim Moore, Loveland, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/259,220

(22) Filed: Oct. 26, 2005

(51) Int. Cl. G06F 3/048

(52) U.S. Cl. 715/772

(57) ABSTRACT

Storage apparatus containing removable media and related methods that filters and displays information regarding events relating to the health of the storage apparatus. A controller is configured to robotically manage the removable media and manage events related to the health of the storage apparatus, wherein the events are classified into one of a number of predetermined event classes. A display is coupled to the controller for displaying the events. An operator control panel is coupled to the controller and is configurable to receive a class selection from a user. In response to a class selection, the controller causes only events associated with the class selection to be displayed.

### BACKGROUND

Businesses, governmental agencies, learning institutions, and other organizations typically operate computers that are interconnected by a network. Network users often store data on hard drives of network servers. Users also store data on their host computers.

Data stored on the network and/or host computers is typically backed-up periodically to create a copy of the data to prevent it from being lost due to mechanical failure or accidental deletion, for example, and/or to produce an archive of the data. Backup operations typically involve storing a copy of all or a portion of the data files on the network and/or host computers to a backup device such as a magnetic tape library having a plurality of magnetic tape drives.

Digital magnetic tape has long been used for data storage in computer systems. The low cost-per-bit stored, long-term retention capability, and portability of magnetic tape cartridges have made them invaluable for storing large quantities of data generated by businesses.

Tape cartridges are used by automated tape library devices. Tape libraries generally handle many tape cartridges to store very large amounts of data. The tape libraries hold the tape cartridges in predefined positions or media slots. When data is required from a particular tape cartridge, a host system communicates via a Small Computer System Interface (SCSI) bus or a Fibre Channel (FC) fabric, for example, with a controller of the tape library. The controller retrieves the particular tape cartridge from its media slot and places the tape cartridge in a tape drive. The host system may then read from or write to the tape cartridge via the tape drive. Also, the host system may query the controller to determine the number of tape cartridges, tape drives, and robotics mechanisms contained in the tape library to manage the tape library.

There are a number of manufacturers of tape libraries that back up and store large quantities of data to digital magnetic tape cartridges. For example, a StorageWorks brand of tape libraries are manufactured in various sizes and configurations. The number of tape cartridges that can be loaded into such tape libraries varies depending upon model, but may be on the order of 400-500 tapes, for example.

A typical tape library usually has a control and display panel (or operator control panel) where local functions are controlled and where the health of the tape library may be displayed. The display typically presents information about components in the tape library that are built by the original library manufacturer. Value added components may also be installed in the tape library including software tools to aid in the configuration, installation, and management of the tape library.

Various errors may occur during operation of the tape library. Such errors may include tape loading errors, and configuration errors, and the like. The errors are stored in error logs.

Heretofore, when evaluating the error logs, a user was required to intuitively sort through many logged events to find those that are of interest. From a conventional control and display panel, there is no opportunity to use common computer tools to perform the sort. Also, the relative level of error as determined by the product is used for the sort. As information is passed on to other devices in the product, it is possible that the language of how to categorize errors will change and some values may be lost.

### BRIEF DESCRIPTION OF THE DRAWINGS

The various features and advantages of embodiments of the present invention may be more readily understood with reference to the following detailed description taken in conjunction with the accompanying drawings, wherein like reference numerals designate like structural elements, and in which:

FIG. 1 is a block diagram that illustrates an exemplary tape library;

FIGS. 2a-2e illustrate exemplary display screens of an exemplary sorting function for use in backup storage or other device; and

FIG. 3 is a flow diagram that illustrates an exemplary method or algorithm for use with backup storage devices.

### DETAILED DESCRIPTION

Backup storage apparatus 10 is disclosed and is discussed below in the context of a magnetic tape library 10. However, it is to be understood that the backup storage apparatus 10 is not limited only to magnetic tape libraries, but may be employed in the context of other storage devices and systems, including optical drives and hard disk drives, for example.

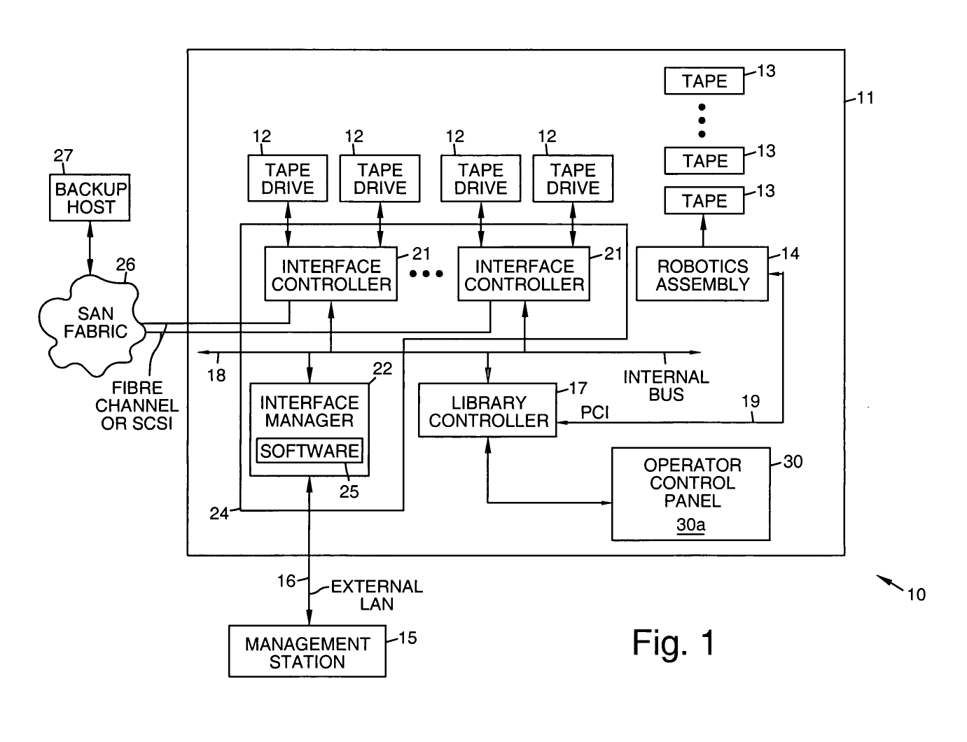

Referring to the drawing figures, FIG. 1 shows exemplary backup storage apparatus 10 comprising an exemplary tape library 10. The exemplary tape library 10 comprises a housing 11 in which a plurality of tape drives 12 (storage devices 12) are housed. A plurality of tape cartridges 13 (storage media 13) are loaded and stored in the housing 11 and which are manipulated by a robotics assembly 14 to load and unload them into a selected tape drive 12 to store data thereon or retrieve data therefrom. In other types of backup storage apparatus 10, the storage device 12 might comprise an optical disk reader used with optical disk media, or removable hard disk drives, for example.

An external management station 15 communicates with the tape library 10 by way of an external local area network (LAN) 16. The management station 15 is coupled by way of the external LAN 16 to a component 22 of the tape library 10 such as an interface manager 22 or management appliance 22. The interface manager 22 or management appliance 22 includes software tools 25 that aid in the configuration, installation, and management of the tape library 10, and specifically allow configuration and control of value added components 24 of the tape library 10. The interface manager 22 is coupled to an internal bus 18 comprising a communication link 18.

One or more interface controllers 21 may be coupled between selected tape drives 12 and the internal bus 18. The interface controllers 21 provide a communication path for the interface manager 22 to talk to the tape drives 12. The interface controllers 21 also provide a controlled data path between the tape drives 12 and a backup server 26. The backup server 26 communicates with the interface controllers 21 via a Fibre Channel fabric 27, shown in FIG. 1 as a storage area network (SAN) fabric 27, for example. A parallel data bus such as a Small Computer System Interface (SCSI) bus may be used in place of the Fibre Channel fabric 27, but this is not commonly used in current-generation computers.

The interface manager 22 or management appliance 22 and the interface controllers 21 comprise the value added components 24 of the tape library 10, i.e., components that may not be manufactured and installed by the original library manufacturer.

A library controller 17 is coupled by way of the internal bus 18 (communication link 18) to the one or more interface controllers 21 and to the interface manager 22 or management appliance 22. The library controller 17 is also coupled by the way of a private internal bus such as a PCI bus 19 to the robotics assembly 14.

The tape library 10 comprises an operator control panel and display system 30, comprising an operator control panel 30 and display 30a, which is preferably disposed on a front panel of the tape library 10, for ease of use. The operator control panel 30 controls local functions and displays information regarding the tape library 10 on the display 30a. The operator control panel 30 presents information about components in the tape library 10.

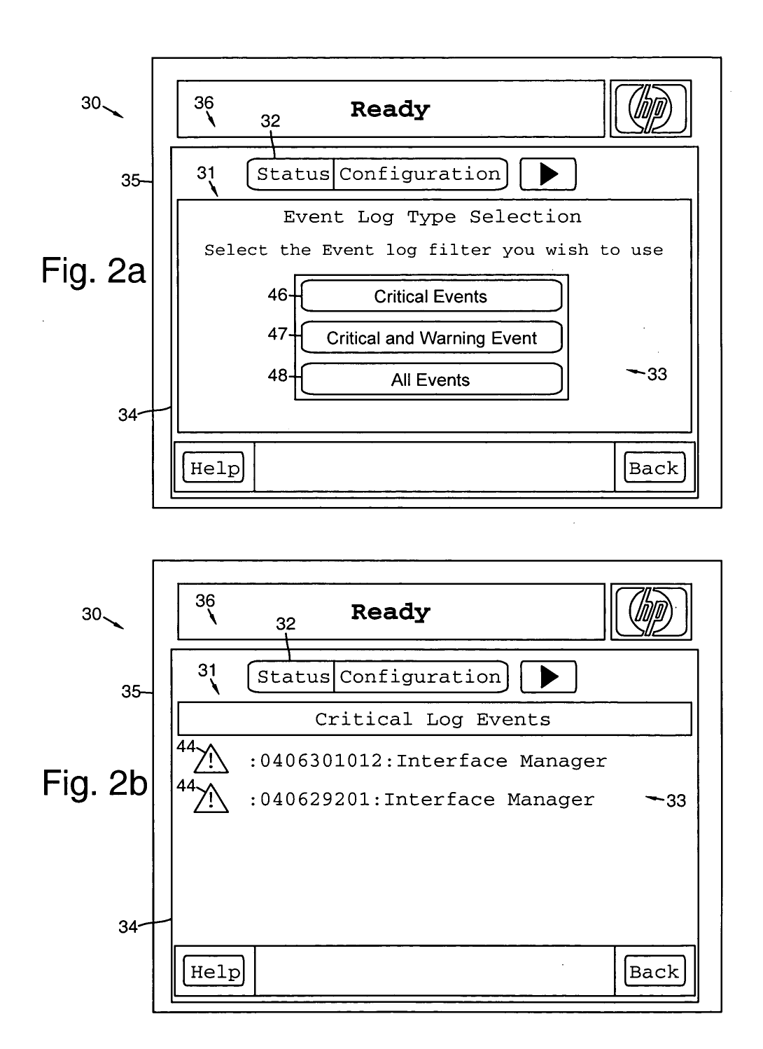

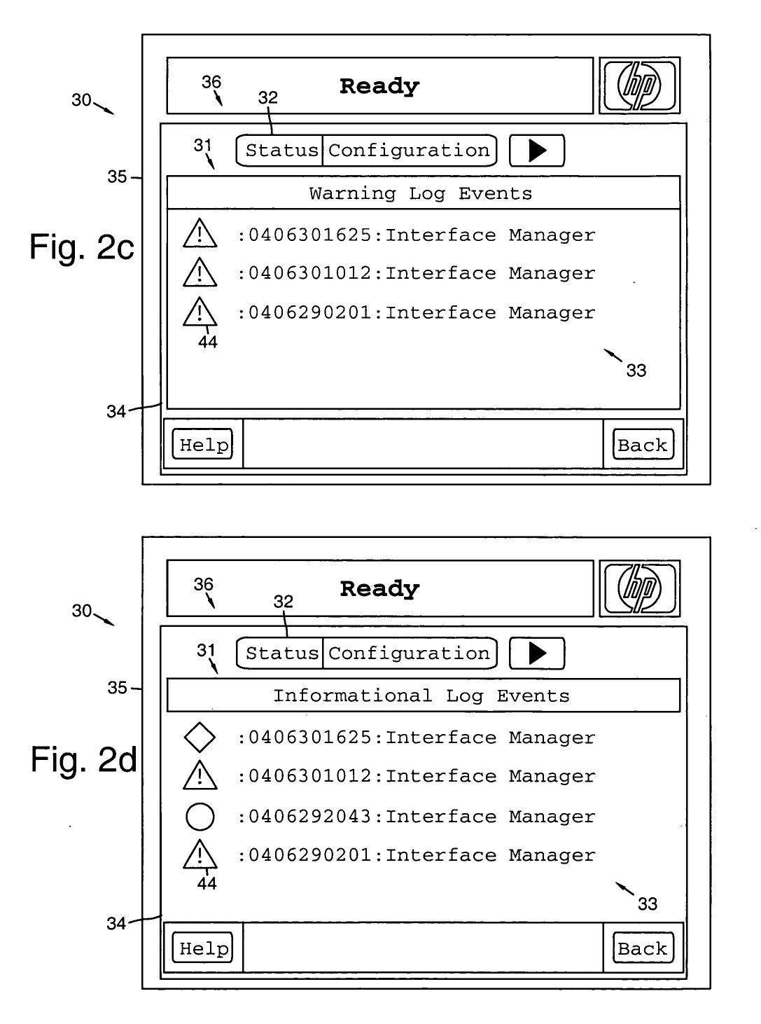

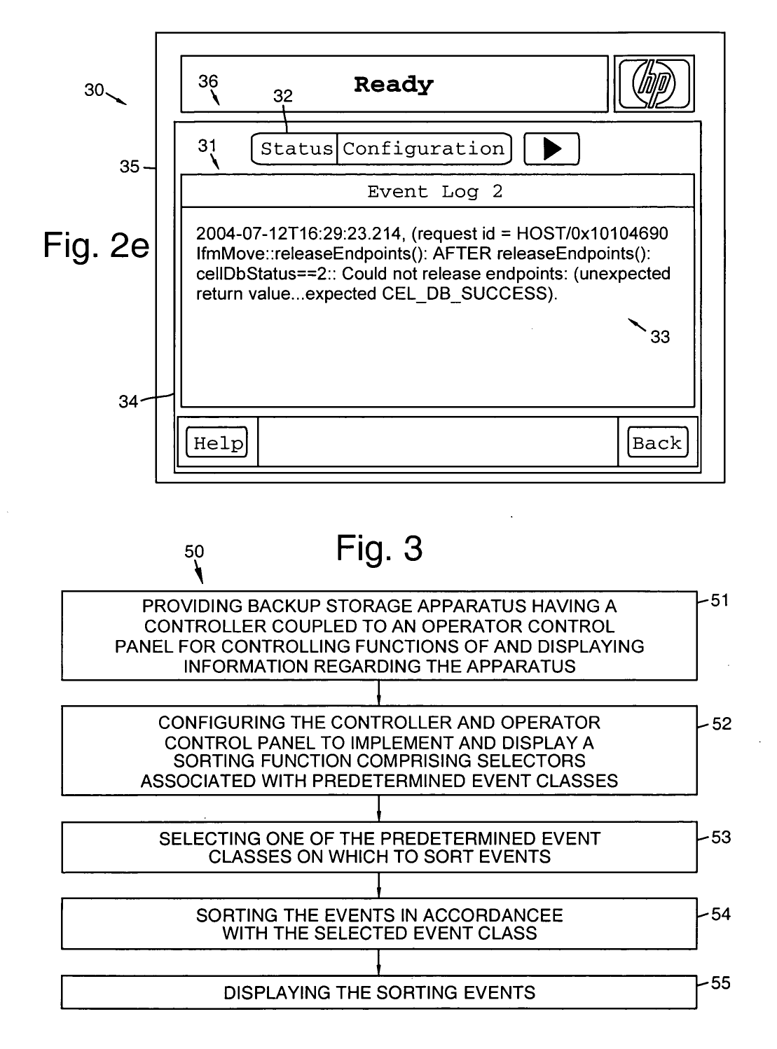

The operator control panel 30 comprises a graphical user interface (GUI) that displays library status information and allows a user to access the library menus. These menus allow a user to view or change the library settings, run demonstration programs, and run diagnostic tests, for example. Certain of these menus are illustrated in and are discussed with reference to FIGS. 2a-2e.

Events are created when certain actions occur during operation of the backup storage apparatus 10, or tape drive 10. For example, if a particular storage medium is near its capacity, if a particular storage medium cannot be found, if there is a communication error between certain components in the backup storage apparatus 10, if a storage medium can't be loaded, or if a component is not configured properly.

Events may occur and logged during operation of the backup storage apparatus 10, or tape library 10. Such events may include errors, warnings, and status information, for example. For example, such events may include tape loading errors, configuration errors, and errors related to various components in the backup storage apparatus 10. Upon the occurrence of an event, such as an error, for example, an event log (error log) is created, which may be stored in the controller 17, for example.

Events may be tagged in accordance with an event status (i.e., they fall into a class), such as errors, warnings, and status information. The backup storage apparatus 10, or tape drive 10, creates a tag when an event occurs that identifies the class to which the event belongs. In one embodiment, events are tagged into a particular class, after which they may be selected according to classes.

When evaluating event (error) logs, for example, a user is normally required to intuitively sort through many logged events to find those that are of interest. In order to make the selection or filtering operation easier for the user, the controller 17 and operator control panel 30 are configured to implement and display an exemplary selection function 33 for predetermined event (error) classes, illustrated with reference to FIGS. 2a-2e.

FIGS. 2a-2e show exemplary screen displays 34 that may be presented on a backup storage device 10, such as a tape library 10, or other device, for example, that relate to the exemplary selection function 33. The exemplary screen displays 34 and exemplary selection function 33 may be presented on a display screen 35 of the operator control panel 30.

The exemplary selection function 33 may be implemented by way of a status menu 36 that is one menu of a menu structure or tree. The operator control panel 30 has a menu structure that has many paths, such as is illustrated by menus 36 shown in FIGS. 2a-2e, of which the status menu 36 is but one.

The exemplary screen display 34 shown in FIG. 2a may be arrived at by migrating through a number of screen displays 34 that present information relating to different aspects of the backup storage device 10, or tape library 10. Exemplary screen displays 34 may include Status, Configuration, Operation and Support screen displays 34, for example, two of which are shown in FIG. 2a.

Clicking on an appropriate selectable identifier 32 (selector 32 or selectable menu item 32) representing the Status, Configuration, Operation and Support screen displays 34 takes the user to lower levels in the menu structure or tree relating to the particular information that is desired. The selectable identifier 32 may comprise an icon, selectable text, label, banner, or other selectable area of the display screen 35, for example.

Status and Configuration selectable identifiers 32 are shown near the top of the screen displays 34 shown in FIGS. 2a-2e. Other screen displays 34, such as Operation and Support screen displays 34, for example, may be viewed by clicking on the right pointing triangular arrow to the right of the Status and Configuration selectable identifiers 32. Selecting one of the selectable identifiers 32 takes the user to a subsequent screen display 34 of the menu structure. Help and Back icons are presented on each of the screen display 34 that allow a user to access one or more help screens relating to what is displayed on the screen display 34, and to return to a previous screen display 34.

The exemplary selection function 33 allows the user to view only certain classes of events or information, including errors, for example. Any number of choices may be displayed to the user on the operator control panel 30. Three exemplary choices include Critical Events, Critical and Warning Events, and All Events, shown FIG. 2a. By selecting one of these available choices, the user can act on an appropriate level of information that is displayed relating to the chosen class of events. Data representative of each of the individual classes of information is illustrated in FIGS. 2b-2d. When a class is selected the user is shown only those events relating to that class.

The operator control panel 30 is thus configured to provide easy and quick navigation to pertinent levels of information relating to classes of errors. This solution minimizes the amount of information that the user is required to evaluate to perform event or error evaluation.

More particularly, FIG. 2a shows an exemplary event log type selection screen 31 that may be arrived at by migrating through predetermined screen displays 34 by clicking on or touching the Status selectable identifier 32, for example. The event log type selection screen 31 allows a user to select one of several event log filters 46-48, for example, that may be used. Exemplary event log filters 46-48 include Critical Events 46, Critical and Warning Events 47, and All Events 48. Clicking on one of the event log filters 46-48 presents another screen display 34 relevant to the selected filter 46-48. Help and Back icons are presented on the screen display 34, as well as the screen displays 34 shown in FIGS. 2b-2e.

FIG. 2b illustrates an exemplary screen display 34 that is presented when the Critical Events event log filter 46 is selected in FIG. 2a. Two critical log events, for example, are displayed relating to the interface manager 22 in the exemplary Critical Log Events screen display 34. Each of the warning log events include a status or warning identifier 44, such as a label 44 or icon 44, for example.

FIG. 2c illustrates and exemplary screen display 34 that is presented when the Critical and Warning Events event log filter 47 is selected in FIG. 2a. Three warning log events, for example, are displayed relating to the interface manager 22 in the exemplary Warning Log Events screen display 34. Each of the warning log events include a status or warning identifier 44, such as a label 44 or icon 44, for example.

FIG. 2d illustrates and exemplary screen display 34 that is presented when the uppermost event log filter 48 is selected in FIG. 2a. The events that are displayed are referred to as Informational Log Events. Four log events, for example, are displayed relating to the interface manager 22 in the exemplary Informational Log Events screen display 34. The first event has a status or warning identifier 44, such as a label 44 or icon 44, for example, (which may be yellow in color, for example) indicating that a minor error has occurred. The second and fourth events have status or warning identifiers 44, such as labels 44 or icons 44 (which may be red in color, for example) indicating that a major error has occurred. The third event has a circular status or warning identifier 44, such as a label 44, for example, (which may be green in color, for example) indicating that there is no problem relating to this event.

FIG. 2e illustrates and exemplary screen display 34 that is presented when the Critical Log Events event shown in FIG. 2b is selected. A screen display 34 is presented identifying Event Log 2, and which indicates specifics of the error that was encountered.

FIG. 3 is a flow diagram that illustrates an exemplary event log selection method 50 or algorithm 50 for use in backup storage apparatus 10, for example. The exemplary method 50 or algorithm 50 may be used with backup storage apparatus 10 such as magnetic tape libraries, optical drives and hard disk drives, for example. The exemplary method 50 or algorithm 50 comprises the following actions.

A backup storage apparatus 10 (tape library 10) is implemented 51 that comprises a controller 17 that controls and monitors a robotics assembly 14 that loads and unloads storage media 13 into and from at least one storage device 12, and an operator control panel 30 comprising a display 30a coupled to the controller 17 for controlling functions of and displaying information regarding the backup storage apparatus 10.

The controller 17 and operator control panel 30 are configured 52 to implement and display a selection function 33 comprising selectors 32 associated with predetermined event classes. A particular event class is selected 53 on which to filter or select events. The events are selected 54 in accordance with the selected event class. The selected events are displayed 55, such as on the display 30a of the operator control panel 30.

Thus, storage apparatus 10 containing removable media and related methods 50 that filter and displays information regarding events relating to the health of the storage apparatus 10. The controller 17 is configured to robotically manage the removable media 13 and manage events related to the health of the storage apparatus 10, wherein the events are classified into one of a number of predetermined event classes. The display 30a is used to display the events. The operator control panel 30 may comprise a display 30a used to display the events and is coupled to the controller 17. The operator control panel 30 is configurable to receive a class selection from a user. In response to a class selection, the controller 17 causes only events associated with the class selection to be displayed.

Thus, improved storage apparatus and related methods or algorithms have been disclosed. It is to be understood that the above-described embodiments are merely illustrative of some of the many specific embodiments that represent applications of the principles described herein. Clearly, numerous and other arrangements can be readily devised by those skilled in the art without departing from the scope of the invention.

1. Storage apparatus containing removable media, comprising:
a controller configured to robotically manage the removable media and to manage events related to the health of the storage apparatus, wherein the events are classified into one of a number of predetermined event classes;
a display coupled to the controller for displaying the events; and
an operator control panel coupled to the controller and configurable to receive a class selection from a user;
wherein in response to the class selection, the controller causes only events associated with the class selection to be displayed.

2. The apparatus recited in claim 1 wherein the predetermined event classes include critical events, critical and warning events, and all events.

3. Storage apparatus containing removable media, comprising:
controller means configured to robotically manage the removable media and to manage events related to the health of the storage apparatus, wherein the events are classified into one of a number of predetermined event classes;
display means coupled to the controller means for displaying the events; and
operator control means coupled to the controller means and configurable to receive a class selection from a user;
wherein in response to the class selection, the controller causes only events associated with the class selection to be displayed.

4. The apparatus recited in claim 3 wherein the predetermined event classes include critical events, critical and warning events, and all events.

5. A method for use with storage apparatus containing removable media, comprising:
configuring a controller to robotically manage the removable media and to manage events related to the health of the storage apparatus, wherein the events are classified into one of a number of predetermined event classes;
displaying the events; and
making a class selection on an operator control panel coupled to the controller;
wherein in response to the class selection, the controller causes only events associated with the class selection to be displayed.

6. The method recited in claim 5 wherein the predetermined event classes include critical events, critical and warning events, and all events.
